(19) United States
(12) Patent Application Publication
(10) Pub. No.: US 2011/0316953 A1
(43) Pub. Date: Dec. 29, 2011

(54) RECORDING MEDIUM HOLDING DEVICE AND IMAGE FORMING APPARATUS

(75) Inventors: Yoshiaki Kaneko, Shizuoka-ken (JP); Hirofumi Kondo, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/166,929

(22) Filed: Jun. 23, 2011

Related U.S. Application Data
(60) Provisional application No. 61/359,153, filed on Jun. 28, 2010.

(51) Int. Cl. B41J 2/01

(52) U.S. Cl. 347/104

(57) ABSTRACT

According to one embodiment, an image forming apparatus includes a drum, a transportation roller, a pressing roller, a power supply, and an image forming unit. The drum rotates, and the transportation roller transports a recording medium to the drum. The pressing roller presses the recording medium transported by the transportation roller on the surface of the drum. The power supply provides charge to the recording medium which is pressed on the surface of the drum by the pressing roller. The image forming unit forms an image on the recording medium which is provided with charge by the power supply and rotates along with the drum while being held on the surface of the drum.

### CROSS-REFERENCE TO RELATED APPLICATIONS

This application is based upon and claims the benefit of priority from U.S. Provisional Application No. 61/359,153 filed on Jun. 28, 2010; the entire contents of which are incorporated herein by reference.

### FIELD

Embodiments described herein relate generally to a recording medium holding device and an image forming apparatus.

### BACKGROUND

Conventionally, there is a device which holds a recording medium such as paper on the surface of a drum which is a holding member by using an electrostatic force. For example, there is a type of image forming apparatus such as an ink jet printer which forms an image on a recording medium while the medium is attracted onto the surface of the drum which is the holding member. In order to form a stabilized image on the recording medium, this type of image forming apparatus needs to reliably attract the recording medium onto the surface of the drum.

### BRIEF DESCRIPTION OF THE DRAWINGS

FIG. 1 is a view schematically illustrating a configuration example of an image forming apparatus.

FIG. 2 is a view illustrating a configuration example of a drum, a pressing roller, and a charging roller.

FIG. 3 is a view for describing a state of the pressing roller and the charging roller which face the surface of the drum.

### DETAILED DESCRIPTION

In general, according to one embodiment, an image forming apparatus includes a drum, a transportation roller, a pressing roller, a power supply, and an image forming unit. The drum rotates, and the transportation roller transports a recording medium to the drum. The pressing roller presses the recording medium transported by the transportation roller on the surface of the drum. The power supply provides charge to the recording medium which is pressed on the surface of the drum by the pressing roller. The image forming unit forms an image on the recording medium which is provided with charge by the power supply and rotates along with the drum while being held on the surface of the drum.

Hereinafter, the embodiments will be described in detail with reference to drawings.

The image forming apparatus according to the present embodiment includes a recording medium holding device holding paper as the recording medium. The image forming apparatus according to the present embodiment forms an image on the recording medium held by the recording medium holding device. The present embodiment can be applied to any image forming apparatus as long as the image forming apparatus includes a mechanism holding a recording medium. For example, the present embodiment can be applied to various types of image forming printers such as an ink jet type printer, an electrophotography type printer, and a thermal transfer type printer.

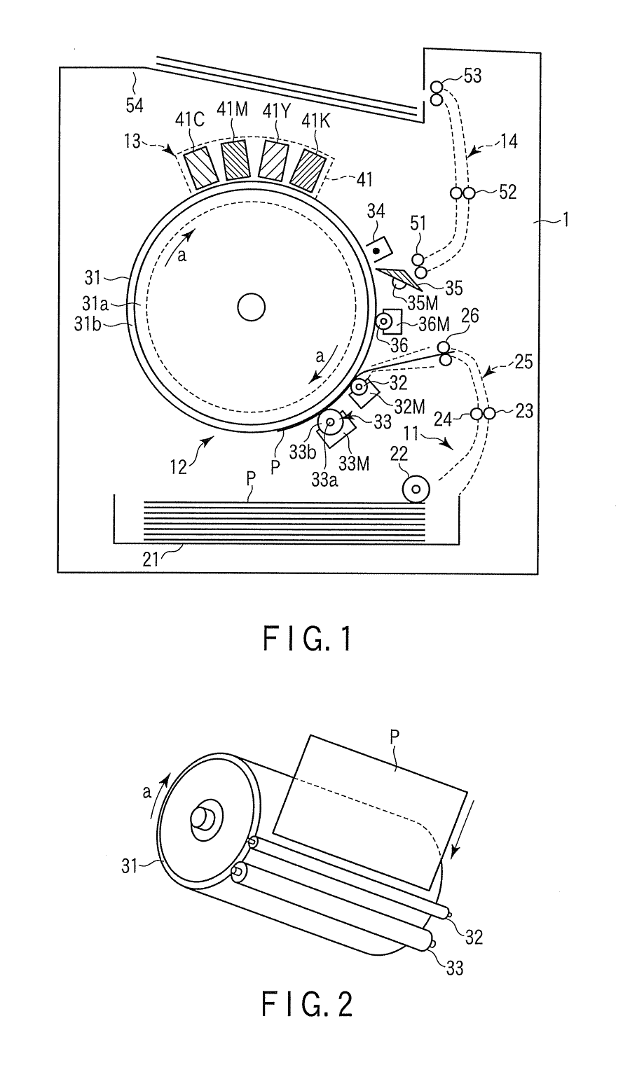

FIG. 1 is a view schematically illustrating a configuration example of an image forming apparatus 1 according to the present embodiment.

The image forming apparatus 1 shown in FIG. 1 is an ink jet type printer (an ink jet printer).

As shown in FIG. 1, the image forming apparatus 1 includes a feeding unit 11, a paper holding unit 12, an image forming unit 13, and a paper discharging unit 14. The feeding unit 11 feeds paper as a recording medium to the paper holding unit 12. The paper holding unit 12 holds the fed paper as the recording medium so that the image forming unit 13 can form an image on the paper. The image forming unit 13 forms an image on the paper that the paper holding unit 12 holds. The paper discharging unit 14 discharges the paper on which an image was formed by the image forming unit 13.

The feeding unit 11 includes a feeding cassette 21, a pickup roller 22, a feeding roller 23, a separation roller 24, a paper transportation path 25, and a pair of resist rollers 26. The feeding cassette 21 stores a plurality of sheets of paper. The pickup roller 22 takes the paper out of the feeding cassette 21. The feeding roller 23 and the separation roller 24 separate the paper taken out by the pickup roller 22 sheet by sheet.

The feeding roller 23 and the separation roller 24 transport paper P separated sheet by sheet to the paper transportation path 25. The paper transportation path 25 guides the paper P transported by the feeding roller 23 and the separation roller 24 to the pair of resist rollers 26. The pair of resist rollers 26 corrects the inclination of the paper P and sends out the paper at a desired timing. The pair of resist rollers 26 sends out the paper P. The paper P has undergone inclination correction to a drum 31 which serves as a recording medium holding member in the paper holding unit 12, at a desired timing.

The paper holding unit 12 includes a function as a recording medium holding device. The paper holding unit 12 includes the drum 31, a pressing roller 32, a charging roller 33, a static elimination charger 34, a peeling member 35, and a cleaning member 36. In the paper holding unit 12, the pressing roller 32, the charging roller 33, the static elimination charger 34, the peeling member 35, and the cleaning member 36 are installed in order at a position facing the surface of the drum 31 which is a paper P-holding member.

The pressing roller 32, the charging roller 33, the peeling member 35, and the cleaning member 36 are respectively connected to separating and abutting mechanisms 32M, 33M, 35M, and 36M. Each of the separating and abutting mechanisms 32M, 33M, 35M, and 36M brings each of the pressing roller 32, the charging roller 33, the peeling member 35, and the cleaning member 36 into contact with the surface of the drum 31 or separates each of the rollers and members from the surface of the drum 31.

The drum 31 is a member holding the paper P as the recording medium. In the configuration shown in FIG. 1, the drum 31 has a cylindrical shape. The drum 31 rotates on the cylindrical axis in a direction a shown in FIG. 1. Furthermore, the drum 31 may be a drum in which the cross-section thereof perpendicular to the rotation direction is flat. The drum 31 includes a cylindrical frame 31a formed of a conductor and a dielectric body 31b on the surface of the frame 31a. For example, in the drum 31 of the configuration example shown in FIG. 1, the frame 31a is formed of a metallic conductor such as aluminum. The dielectric body 31b is formed into a thin layer on the surface of the cylindrical frame 31a formed of a conductor. The inside of the frame 31a is grounded, so the potential thereof becomes 0 [v]. The inside of the frame 31a serves as an ohmic electrode with respect to the charging roller 33, and the potential thereof is held at 0 [v].

The pressing roller 32 rotates in response to the rotation of the drum 31 while contacting the surface of the drum 31. The outer circumferential surface of the pressing roller 32 contacting the surface of the drum 31 is constituted by an elastic body. For example, before the pair of resist rollers 26 sends out the paper, the pressing roller 32 is pressed on the surface of the drum 31 by the separating and abutting mechanism 32M. The pressing roller 32 pressed on the drum 31 by the separating and abutting mechanism 32M rotates in response to the rotation of the drum 31 while being deformed according to the surface shape of the drum 31.

The paper P sent out from the pair of resist rollers 26 starts to be nipped between the pressing roller 32 and the surface of the drum 31. By applying pressure to the paper P if nipping the paper with the surface of the drum 31, the pressing roller 32 makes the paper P adhere to the surface of the drum 31 while smoothing out unevenness such as wrinkles in the paper P. The separating and abutting mechanism 32M for the pressing roller 32 presses the pressing roller 32 on the surface of the drum 31 with a load required to make the paper P adhere to (wind around) the surface of the drum 31.

The paper P adhered to the surface of the drum 31 by the pressing roller 32 moves due to the rotation of the drum 31 and starts to be nipped between the charging roller 33 and the surface of the drum 31.

The charging roller 33 includes a cored bar 33a extending along the line of the rotation axis and a cylindrical conductive member 33b provided outside of the cored bar 33a. In the charging roller 33, voltage is applied to the cored bar 33a. The charging roller 33 rotates in response to the rotation of the drum 31 while the cylindrical conductive member 33b contacts the surface of the drum 31. Before the pair of resist rollers 26 sends out the paper, the charging roller 33 is pressed on the surface of the drum 31 by the separating and abutting mechanism 33M. The paper which passed through the nip of the pressing roller 32 and the drum 31 starts to be nipped between the charging roller 33 and the drum 31.

If the paper P starts to be nipped between the charging roller 33 and the drum 31, high voltage is applied to the cored bar 33a of the charging roller 33. Since the inside of the drum 31 is grounded, potential difference which is created by the potential applied to the charging roller 33 is applied to the nipping site of the charging roller 33 and the drum 31. That is, at the nipping site of the charging roller 33 and the drum 31, the charging roller 33 provides charge to the paper P which adheres to the surface of the drum 31 by the voltage applied to the cored bar 33a.

The paper P provided with the charge by the charging roller 33 is attracted onto the surface of the drum 31 by the electrostatic force. The drum 31 rotates while attracting (holding) the paper P onto the surface thereof. The paper P attracted onto the surface of the drum 31 moves along with the rotation of the drum 31 to a position where the image forming unit 13 forms an image.

The image forming unit 13 includes a print head group 41 including a plurality of print heads 41C, 41M, 41Y, and 41K. Each print head 41 is installed so as to face the surface of the drum 31. The print head 41C discharges cyan ink, the print head 41M discharges magenta ink, the print head 41Y discharges yellow ink, and the print head 41K discharges black ink.

By discharging ink based on the image information, each print head 41 forms an image on the surface of the paper P which is attracted onto the surface of the drum 31. Moreover, the drum 31 rotates by a number of rotations determined according to the printing condition while attracting the paper P onto the surface thereof. The drum 31 can move the paper P attracted onto the surface thereof to the image formation position, by the same number of times as the number of rotations of the drum 31. In other words, the print head 41 of the image forming unit 13 can repeatedly form the image on the paper P by the same number of times as the number of rotations of the drum 31.

For example, if a configuration is employed in which an image for a single color is formed whenever the drum 31 rotates once, the respective image is formed on the paper which rotates four times along with the drum 31 with four colors (cyan, magenta, yellow, and black) of ink constituting full color, whereby a full color image can be formed. Moreover, if an image having a higher resolution compared to the physical resolution of the print head 41 itself is formed, the image is formed a plurality of times on the paper which rotates a plurality of times along with the drum 31, whereby the high-resolution image can be formed. In addition, if a high-density image is formed, the image is formed a plurality of times on the paper which rotates a plurality of times along with the drum 31, whereby the high-density image can be formed.

If the image formation is performed a plurality of times by rotating the paper attracted onto the drum 31 twice or more, each of the peeling member 35, the cleaning member 36, the pressing roller 32, and the charging roller 33 may be separated from the surface of the drum 31 by each of the separating and abutting mechanisms 35M, 36M, 32M, and 33M. That is, after the paper P is attracted onto the surface of the drum 31, the peeling member 35, the cleaning member 36, the pressing roller 32, and the charging roller 33 are kept separated from the surface of the drum 31 until the image is completed, whereby it is possible to prevent the peeling member 35, the cleaning member 36, the pressing roller 32, and the charging roller 33 from contacting the paper P.

The paper P on which the image was formed by the image forming unit 13 is peeled off the surface of the drum 31, and then sent out to the paper discharging unit 14. If the image forming unit 13 completes the image formation with respect to the paper P, the static elimination charger 34 eliminating static electricity of the paper P, and the peeling member 35 peels off the paper P from the surface of the drum 31.

The static elimination charger 34 eliminates the charge from the paper attracted onto the surface of the drum 31. The static elimination charger 34 eliminates static electricity without contacting the surface of the drum 31 and the paper P. For example, the static elimination charger 34 applies AC potential to the paper P attracted onto the surface of the drum 31 by using a corona discharger. By applying the AC potential to the drum 31 and the paper P, the static elimination charger 34 eliminates the electrostatic force of the drum 31 used for attracting the paper P.

The peeling member 35 peels off the paper P from the surface of the drum 31. If the paper P is peeled off the surface of the drum 31, the peeling member 35 is brought into contact with the surface of the drum 31 by the separating and abutting mechanism 35M. Before the leading end of the paper P to be peeled reaches a position where the peeling member 35 peels the paper, the separating and abutting mechanism 35M brings the peeling member 35 into contact with the surface of the drum 31. Until the image formation with respect to the paper P which is attracted onto the surface of the drum 31 is completed, the separating and abutting mechanism 35M separates the peeling member 35 from the surface of the drum 31. Furthermore, the peeling member 35 guides the paper P peeled off the surface of the drum 31 to a transportation roller 51 of the paper discharging unit 14.

Between the peeling member 35 and the pressing roller 32, the cleaning member 36 is installed. The cleaning member 36 cleans the surface of the drum 31. The separating and abutting mechanism 36M presses the cleaning member 36 on the surface of the drum 31 from which the paper P was peeled. If the drum 31 rotates while the cleaning member 36 is pressed on the surface of the drum 31, the cleaning member 36 cleans the surface of the drum 31.

The paper discharging unit 14 includes a plurality of transportation rollers 51, 52, and 53 as well as a paper-discharge tray 54. The paper P peeled off the surface of the drum 31 by the peeling member 35 is fed to the transportation roller 51. The transportation roller 51 sends out the paper P fed from the peeling member 35 to the transportation roller 52. The transportation roller 52 sends out the paper P fed from the transportation roller 51 to the transportation roller 53. The transportation roller 53 discharges the paper P fed from the transportation roller 52 to the paper-discharged tray 54.

Next, the configuration and action of the drum 31, the pressing roller 32 and the charging roller 33 will be described.

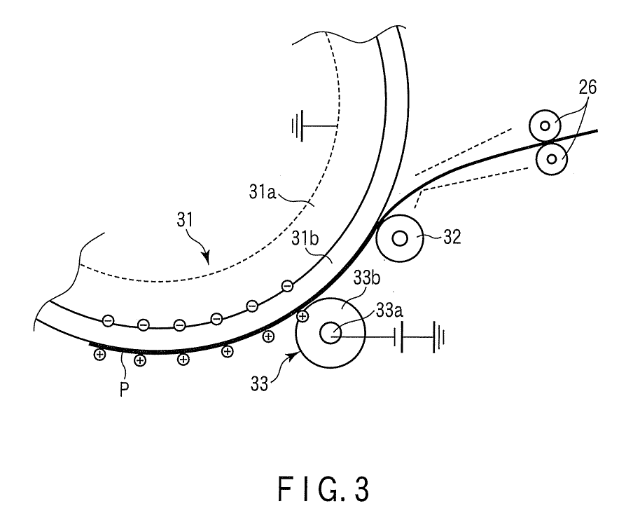

FIG. 2 is a perspective view illustrating the configuration example of the drum 31, the pressing roller 32, and the charging roller 33. FIG. 3 is a view for describing the state of the pressing roller 32 and the charging roller 33 which face the surface of the drum 31.

The drum 31 rotates on the cylindrical axis in the direction a. The pressing roller 32 and the charging roller 33 rotate in response to the rotation of the drum 31 while contacting the surface of the drum 31. The pressing roller 32 is pressed on the surface of the drum 31 by the separating and abutting mechanism 32M. The charging roller 33 is pressed on the surface of the drum 31 by the separating and abutting mechanism 33M. As described above, before the pair of resist rollers sends out the paper P as the recording medium, the separating and abutting mechanisms 32M and 33M press the pressing roller 32 and the charging roller 33 on the surface of the drum 31.

The paper P on which the image is formed is sent out from the pair of resist rollers 26, and nipped between the pressing roller 32 and the drum 31. The pressing roller 32 makes the fed paper P adhere to the surface of the drum 31, at the nipping site of the pressing roller 32 and the surface of the drum 31. The pressing roller 32 smoothes out the unevenness such as wrinkles in the paper P at the nipping site of the pressing roller 32 and the drum 31, thereby improving the adherence between the paper P and the surface of the drum 31.

That is, the pressing roller 32 has a function of correcting the unevenness in the paper P by smoothing out the unevenness and making the paper P adhere to the surface of the drum 31 at the same time. Accordingly, the pressing roller 32 is configured with an elastic body which is deformed in response to the strength by which the pressing roller 32 is pressed on the surface of the drum 31. Moreover, the pressing roller 32 needs to be so configured that the charge provided to the paper P from the charging roller 33 does not leak. Consequently, the outer circumferential surface of the pressing roller 32 is configured with an insulator. The surface of the pressing roller 32 is configured with, for example, an elastic body having an insulation property so as to include all of the above conditions.

The pressing roller with this configuration can smooth out the unevenness such as wrinkles in the paper P; also, the roller can feed the paper in which the unevenness such as wrinkles was corrected to the position where the charging roller 33 supplies power, while the paper is attracted onto the surface of the drum 31. In addition, by improving the adherence between the paper P and the surface of the drum 31 before the paper reaches the position where the charging roller 33 contacts the surface of the drum 31, it is possible to improve the attracting force caused by the electrostatic force, between the paper P and the surface of the drum 31.

The paper P pressed on the surface of the drum 31 by the pressing roller 32 moves along with the rotation of the drum 31 while being held on the surface of the drum. The paper P which is pressed by the pressing roller 32 and held on the surface of the drum 31 moves so as to be nipped between the charging roller 33 and the surface of the drum 31. At the nipping site of the charging roller 33 and the surface of the drum 31, the charging roller 33 provides charge to the paper P.

The inside of the drum 31 is grounded so as to be 0 [V]. Accordingly, if high voltage is applied to the charging roller 33, potential difference between the inside of the drum and the charging roller is applied as voltage to the nipping site between the charging roller 33 and the surface of the drum 31. As a result, as shown in FIG. 3, the charge is provided to the paper P. The paper P provided with the charge is attracted onto the surface of the drum 31 by the electrostatic force. The electrostatic force created in the paper P and on the surface of the drum 31 is maintained until the paper P loses the charge. Consequently, even while the drum 31 rotates a plurality of times, the attracting force between the paper P and the surface of the drum 31 is maintained unless the paper P loses the charge. As a result, the drum 31 can continuously hold the paper P on the surface thereof.

The charging roller 33 as a power supply member provides charge to the paper P by contacting the paper P. The charging roller 33 as a power supply member, which provides charge by contacting the paper P, includes, for example, the cored bar 33a formed of a metal and the cylindrical conductive member 33b provided outside the cored bar 33a. The cored bar 33a is connected to a circuit for applying voltage. The voltage is applied to the cored bar 33a of the charging roller 33 before the paper P is nipped between the drum 31 and the charging roller 33. The conductive member 33b is formed of a conductive material selected from a conductive rubber or a metal. Examples of the conductive rubber include EPDM (ethylene propylene dienomethylene rubber) in which a conductive filler is mixed.

The power supply member may provide charge to the paper P without contacting the paper P. A non-contact type power supply member may be installed instead of the charging roller 33. The power supply member which provides charge in a non-contact manner may provide charge to the paper P on the surface of the drum 31 by using the potential difference between the power supply member and the grounded drum 31, for example. As the power supply member which provides charge in a non-contact manner instead of the charging roller 33, a wire charger or the like can be used.

As described above, in the image forming apparatus of the present embodiment, the fed paper is pressed on the surface of the drum by the pressing roller, the pressing roller provides charge to the paper pressed on the surface of the drum, the paper provided with the charge is rotated along with the drum while being attracted onto the surface of the drum by the electrostatic force, and an image is formed by the ink jet head on the paper which rotates while being attracted onto the surface of the drum.

According to the image forming apparatus of the present embodiment, the unevenness in the paper fed for forming an image can be efficiently eliminated, and the attracting force between the paper and the surface of the drum can be improved. As a result, in the image forming apparatus of the present embodiment, since the paper is reliably attracted onto the surface of the drum, it is possible to prevent the deterioration of the image quality caused by the misalignment or the like of ink.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording medium holding device comprising:
a drum which rotates;
a transportation roller which a recording medium to the drum;
a pressing roller which passes the recording medium transported by the transportation roller on the surface of the drum; and
a power supply which provides charge to the recording medium which is pressed on the surface of the drum by the pressing roller.

2. The recording medium holding device according to claim 1,
wherein the power supply supplies power while contacting the recording medium pressed on the surface of the drum.

3. The recording medium holding device according to claim 2,
wherein the power supply is a charging roller which rotates in response to the rotation of the drum while contacting paper on the surface of the drum.

4. The recording medium holding device according to claim 3,
wherein the surface of the charging roller is formed of a metal.

5. The recording medium holding device according to claim 3,
wherein the surface of the charging roller is formed of a conductive rubber.

6. The recording medium holding device according to claim 1,
wherein the power supply supplies power without contacting the recording medium pressed on the surface of the drum.

7. The recording medium holding device according to claim 1 further comprising:
a separator which separates the pressing roller from the surface of the drum, after the recording medium passed through the nipping of the pressing roller and the drum.

8. The recording medium holding device according to claim 1 further comprising:
a peeler which peels off the recording medium from the surface of the drum which rotates while attracting the recording medium.

9. The recording medium holding device according to claim 8 further comprising:
a static eliminator which eliminates static electricity of the recording medium attracted onto the surface of the drum right in front of a position where the peeler which performs peeling.

10. An image forming apparatus comprising:
a drum which rotates;
a transportation which roller transports a recording medium to the drum;
a pressing roller which presses the recording medium transported by the transportation roller on the surface of the drum;
a power supply which provides charge to the recording medium which is pressed on the surface of the drum by the pressing roller; and
an image forming unit forms an image on the recording medium which provided with charge by the power supply and rotates along with the drum while being held on the surface of the drum.

11. The image forming apparatus according to claim 10,
wherein the image forming unit includes ink jet heads discharging ink to the recording medium.

12. The image forming apparatus according to claim 10,
wherein the power supply supplies power while contacting the recording medium pressed on the surface of the drum.

13. The image forming apparatus according to claim 12,
wherein the power supply is a charging roller which rotates in response to the rotation of the drum while contacting paper on the surface of the drum.

14. The image forming apparatus according to claim 13,
wherein the surface of the charging roller is formed of a metal.

15. The image forming apparatus according to claim 13,
wherein the surface of the charging roller is formed of a conductive rubber.

16. The image forming apparatus according to claim 10,
wherein the power supply supplies power without contacting the recording medium pressed on the surface of the drum.

17. The image forming apparatus according to claim 10 further comprising:
a separator which separates the pressing roller from the surface of the drum, after the recording medium passed through the nipping of the pressing roller and the drum.

18. The image forming apparatus according to claim 10 further comprising:
a peeler which peels off the recording medium from the surface of the drum which rotates while attracting the recording medium.

19. The image forming apparatus according to claim 18 further comprising:
a static eliminator which eliminates static electricity right in front of a position where the peeler peels off the recording medium from the surface of the drum.

20. The image forming apparatus according to claim 18 further comprising:
a cleaner which cleans the surface of the drum behind a position where the recording medium is peeled off by the peeler.
